(19) United States
(12) Patent Application Publication
(10) Pub. No.: US 2004/0007909 A1
(43) Pub. Date: Jan. 15, 2004

(54) Remote-actuated release handle lockout

(76) Inventor: Jeffery T. Bonk, Clinton Township, MI (US)

Correspondence Address: HARNESS, DICKEY & PIERCE, P.L.C., P.O. BOX 828, BLOOMFIELD HILLS, MI, 48303, US

(21) Appl. No.: 10/191,831

(22) Filed: Jul. 9, 2002

(51) Int. Cl. B60N 2/20

(52) U.S. Cl. 297/378.13

(57) ABSTRACT

A latch mechanism is provided and includes a housing, a latch assembly operably supported by the housing, and a toggle lever slidably supported by the housing. The toggle lever is in operable communication with the latch assembly for selectively actuating the latch assembly between a latched and unlatched position. The toggle lever is movable between first and second modes for respectively establishing first and second pivot axis. In the first mode, the toggle lever is operable for actuating the latch assembly and in the second mode, the toggle lever is inoperable for actuating the latch assembly.

### FIELD OF THE INVENTION

The present invention relates to latch mechanisms and more particularly to an improved latch mechanism for seat assemblies.

### BACKGROUND OF THE INVENTION

In automotive applications, it is desirable that a vehicle be capable of accommodating varying requirements, such as cargo carrying and the like. To that end, reconfiguration of the vehicle seating system plays a significant role. Dumping and articulation of a seatback enables a vehicle interior to be configurable for accommodating cargo-carrying needs. Further, such seat adjustments often provide access to a cargo area of a vehicle, thus improving storage capability and providing for large objects. Typically, latching mechanisms are utilized to anchor a seatback to a secure vehicle structure and allow an occupant to selectively disengage the latching mechanism to position the seatback as desired.

Typical latching mechanisms function through a remote actuator operable by the occupant. Generally, the latching mechanism may be selectively actuated between the unlatched and latched position by actuating a lever. The actuation of the lever, and the subsequent unlatching of the latch mechanism, disengages the seatback from the vehicle structure to enable access to a storage area behind the seatback, such as a trunk. Current latching systems suffer from the disadvantage that they do not allow for the latching system to be locked out from use when access to the storage area is to be prohibited.

In vehicle design, occupant safety is also a significant concern. In particular, with respect to seat systems, occupant safety can be increased by ensuring the seat components are in their proper operational positions. For example, it is undesirable to allow an occupant to sit in a seat when the seatback is not properly secure. Many latching mechanisms fail to provide a sensing feature for ensuring proper positioning and/or locking of seat components.

Therefore a latch mechanism that securely latches a seat to a vehicle structure providing for selective dumping or articulation of the seat for access to a cargo area of the vehicle is desirable in the industry. Furthermore, preventing articulation of a seat to prevent access to a cargo area of a vehicle is desirable in certain situations. A latch mechanism having a sensing structure for prohibiting occupancy of the seat when components of the seat are not properly secure is also desirable.

### SUMMARY OF THE INVENTION

Accordingly, the present invention provides a latch mechanism including a housing, a latch assembly operably supported by the housing, and a toggle lever slidably supported by the housing and in operable communication with the latch assembly to selectively actuate the latch assembly between latched and unlatched positions. The toggle lever is movable between first and second modes for respectively establishing first and second pivot axis, wherein in the first mode the toggle lever is operable to actuate the latch assembly and in the second mode the toggle lever is inoperable to actuate the latch assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a latch mechanism in accordance with the principles of the present invention;

FIG. 2 is an exploded view of the latch mechanism of FIG. 1;

FIG. 3 is a plan view of the latch mechanism with part of a housing removed to show the internal workings of the latch mechanism in the latched position;

FIG. 4 is a plan view of the latch mechanism with part of the housing removed to show the internal workings of the latch mechanism in the unlatched position;

FIG. 5 is a plan view of the latch mechanism with part of the housing removed to show the internal workings of the latch mechanism in a second operable mode; and

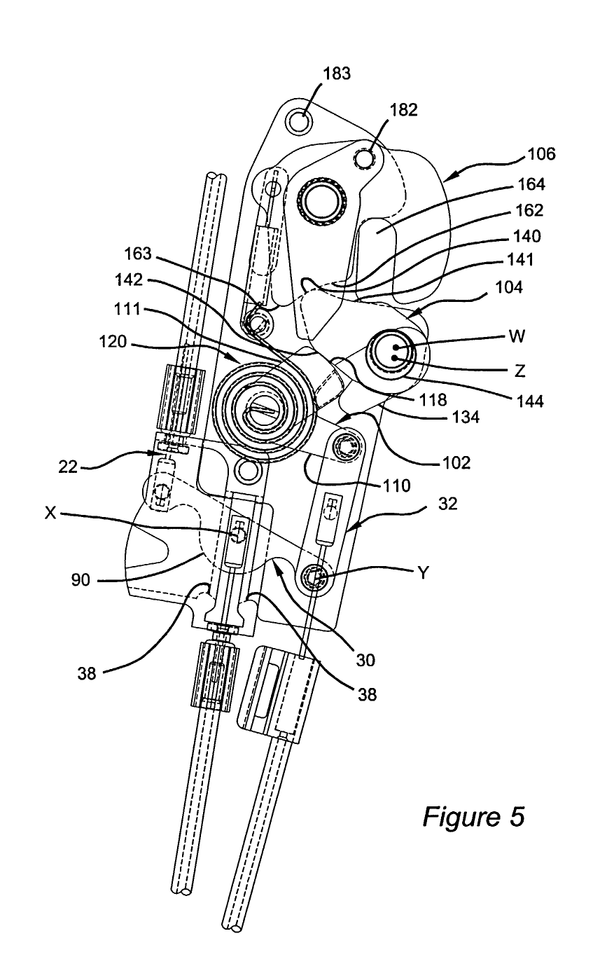

FIG. 6 is a side view of the latch mechanism in a seat assembly.

### DETAILED DESCRIPTION OF THE PREFERRED EMBODIMENTS

The following description of the preferred embodiment is merely exemplary in nature and is in no way intended to limit the invention, its application, or uses. While the present invention is shown in an automotive seatback, the latch shown in the present invention may be used in other automotive and non-automotive applications as well.

With reference to the figures, a latch mechanism 10 is provided and includes a housing 12, a toggle assembly 14 and a latch assembly 16. The toggle assembly 14 and latch assembly 16 are in operable communication with one another and are supported by the housing 12. The housing 12 includes first and second housing plates 18, 20, between which the various components are supported.

An actuation cable 22 is provided to selectively actuate the toggle assembly 14, in turn selectively actuating the latch assembly 16. A valet cable 24 is also included enabling remote actuation of the toggle assembly 14 between first and second operable modes. A retractor cable 26 is optionally provided for establishing communication between the latch mechanism 10 and a seatbelt retractor assembly, as detailed herein below. It should be noted that the various cables are similarly formed and therefore will be indicated using like reference numerals for like components.

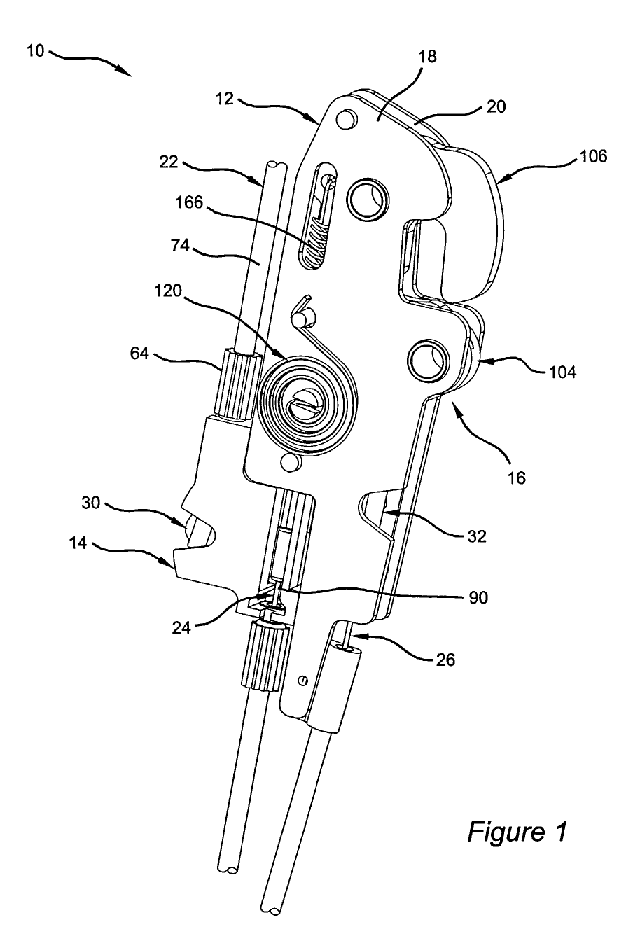

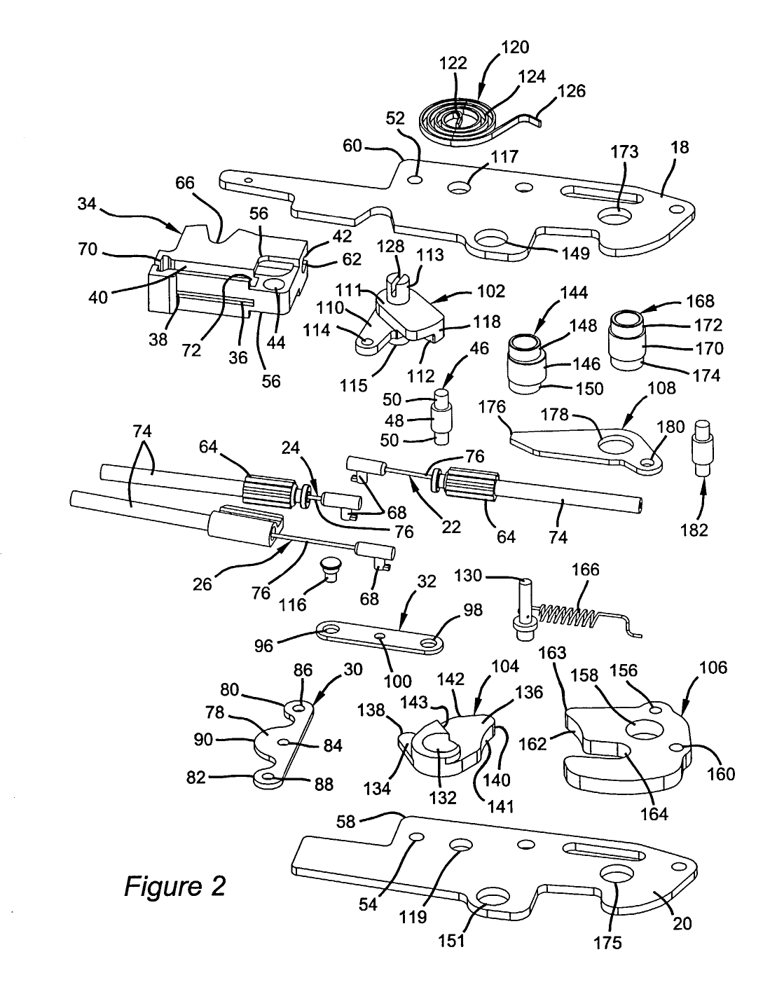

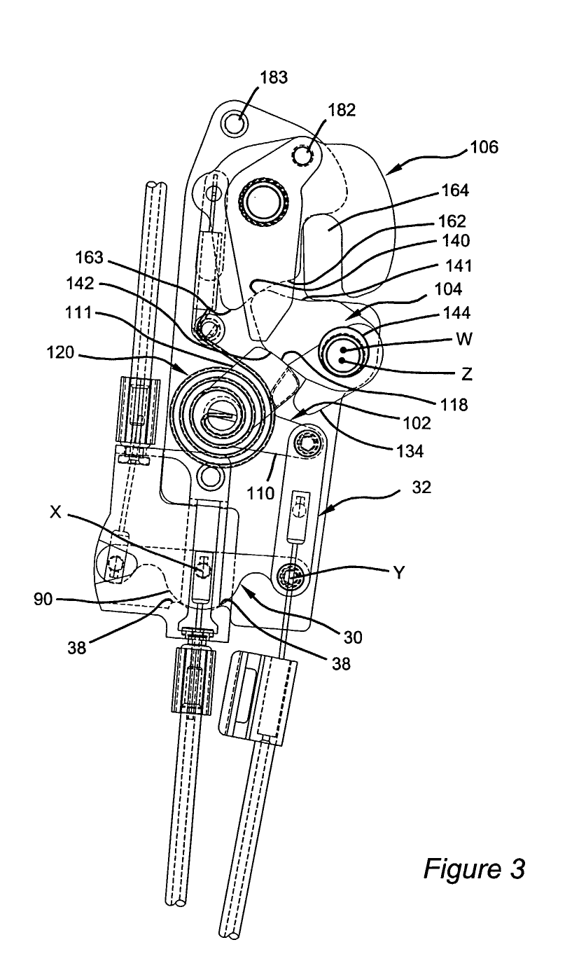

As shown in FIGS. 1 through 4, the toggle assembly 14 includes a toggle lever 30 operably connected to a link 32 for communication with the latch assembly 16. The toggle lever 30 is slidably supported by a toggle housing 34 and pivots therein. The toggle assembly 14 includes the actuation and valet cables 22, 24 for remote actuation thereof and is supported between the first and second housing plates 18, 20.

The toggle housing 34 includes a square body having a toggle slot 36 formed therethrough, a reaction face 38 formed within the toggle slot 36, a valet cable slot 40 formed therein for holding the valet cable 24, an actuation cable slot 42 formed therein for holding the actuation cable 24 and an aperture 44 formed therethrough. A rivet 46 is provided and is received through the aperture 44 for supporting the toggle housing 34 between the first and second housing plates 18, 20. The rivet 46 includes a central cylindrical body 48 and flanking cylindrical bodies 50 extending therefrom and which are received into apertures 52, 54 of the first and second housing plates 18, 20 for supporting the rivet 46 therebetween. Further, the toggle housing 34 includes recesses 56 for respectively receiving corner portions 58, 60 of the first and second housing plates 18, 20 therein. In this manner, outer surfaces of the first and second housing plates 18, 20, respectively, are flush with respective surfaces of the toggle housing.

The actuation cable slot 42 includes an elongate cutout in the body of the toggle housing 34 with a first end 62 designed to receive a cable housing lock member 64 and a second end 66, through which a cable post 68 attaches to the toggle lever 30. The valet cable slot 40 is disposed on an opposite face of the toggle housing 34 from the actuation cable slot 42. The valet cable slot 40 includes an elongate cutout in the body of the toggle housing 34 with a first end 70 receiving a cable housing lock member 64 and a second end 72 through which a cable post 68 attaches to the center aperture 84 of the toggle lever 30.

The actuation cable 22 includes a cable housing 74, a cable housing lock member 64, and a cable 76 ending with the cable post 68. The cable housing 74 includes an elongate cylindrical body, hollow along its length, extending from the base of the cable housing lock member 64. The cable housing lock member 64 includes a cylindrical body, a cylindrical recess and a cylindrical cap. The cylindrical body includes a plurality of ribs or grooves and is hollow along its length. Further, the cable housing lock member 64 employs a taper to reduce its cross section, thereby creating a cylindrical recess including an end cap therein. The cable 76 extends from the end cap to the cable post 68. In the preferred embodiment, the cable 76 is made from a plurality of smaller wound steel cables. In other embodiments, the cable 76 can be made from other suitable materials. The cable post 68 includes a cylindrical housing, a post and a tab. The cylindrical housing is an elongate body, hollow at its first end for securing the cable 76 therein, and capped at its second end. The cylindrical body post extends generally perpendicular to the cylindrical housing and includes a tab projecting generally perpendicular therefrom and generally parallel to the cylindrical housing. It will be appreciated that the valet cable 24 is generally of a similar construction to that of the actuation cable 22. Therefore a detailed description of the valet cable 24 is not provided.

The toggle lever 30 includes a central portion 78 having first and second arms 80, 82 extending therefrom, an aperture 84 formed through the central portion 78, apertures 86, 88 respectively formed through the first and second arms 80, 82 and a reaction face 90 formed on an arcuate internal surface of the central portion 78. The aperture 86 enables connection of the actuation cable 22 to the first arm 80 and the aperture 88 enables connection of the link 32 to the second arm 82. The aperture 84 enables connection of the valet cable 24 to the central portion 78. The reaction face 90 selectively engages the reaction face 38 of the toggle housing 34. In the first operative mode, the reaction faces 34, 90 are held in slidable contact with one another, as described further below, to provide a central pivot axis X of the toggle lever 30. In the second operable mode, the reaction faces 34, 90 are removed from contact with one another, as described further below, to provide an offset pivot point Y of the toggle lever 30.

The link 32 includes a flat body having apertures 96, 98 formed through respective ends. The aperture 96 enables pivotal connection of the link 32 to the second arm 82 of the toggle lever 30 and the aperture 98 enables connection of the link 32 to the latch assembly 16, thereby operably interconnecting the toggle assembly 14 and the latch assembly 16. An aperture 100 is optionally provided through a central length of the flat body for optional connection with the retractor cable 26 as described further below.

The latch assembly 16 generally includes a cam 102, a locking member 104, a latch 106 and a latch plate 108. The cam 102 is operably connected to the link 32 for communication with the toggle assembly 14 and is supported between the first and second housing plates 18, 20. The cam 102 includes an actuation arm 110, a cam extension 111 having a recess 112 formed therein, and extending support posts 113, 115. The extending support posts 113, 115 each include a bearing surface and are received through respective apertures 117, 119 of the first and second housing plates 18, 20. The cam 102 is pivotably supported between the first and second housing plates 18, 20, rotating about the bearing surfaces. The actuation arm 110 includes an aperture 114 for operable connection to the link 32 by a rivet 116. The cam extension 111 includes an engagement face 118.

The cam 102 is biased into engagement with the locking member 104 by a coil spring 120. The coil spring 120 includes a central flat 122, a series of coils 124, and an extending arm 126. The central flat 122 is received into a groove 128 formed in the support post 113 of the cam 102 and the extending arm 126 seats against an anchor post 130 extending from the first housing plate 18. It should also be noted that the support posts 113, 115 are preferably integrated with the cam 102. However, it is anticipated that the support posts 113, 115 may be separate members attached by suitable means, such as a press fit or a weld, into a provided aperture or mounting surface of the cam 102.

The locking member 104 includes a pivot aperture 132, a first extension 134, and a second extension 136. The second extension 136 includes a latch engagement face 140 and a cam engagement face 142. A recess is formed along a length of the second extension 136 to form a face 143. The locking member 104 is operably supported between the first and second housing plates 18, 20 by a locking member pivot 144, which includes a hollow central cylindrical section 146 with first and second hollow cylindrical sections 148, 150 axially extending therefrom, each having bearing surfaces. The first and second hollow cylindrical sections 148, 150 are respectively received into apertures 149, 151 of the housing plates 18, 20, to rotatably support the first and second hollow cylindrical sections 148, 150 therebetween. The central cylindrical section 146, which is of a larger diameter than the first and second cylindrical sections 148, 150, is press fit into the pivot aperture 132 of the locking member 104. Further, a center axis W of the central cylindrical section 146 is offset from a central axis Z of the first and second cylindrical sections 148, 150. Thus, as the locking member 104 is caused to pivot, pivotal motion thereof is supported by the locking member pivot 144, whereby axis W rotates about the central axis Z. In this manner, the locking member 104 not only rotates between the first and second housing plates 18, 20, but also shifts therebetween.

The latch 106 is a flat plate including a spring aperture 156, a pivot aperture 158, an attachment aperture 160, a reaction face 162, and a striker recess 164. The spring aperture 156 provides an attachment for a latch spring 166. The pivot aperture 160 receives a latch pivot 168 therethrough for pivotably supporting the latch 106. The latch pivot 168 includes a hollow central cylindrical 170 section with first and second hollow cylindrical sections 172, 174 axially extending therefrom, each having bearing surfaces. The first and second cylindrical sections 172, 174 are received into respective apertures 173, 175 of the first and second housing plates 18, 20 and are pivotably supported therebetween. The central cylindrical section 170 is received through the pivot aperture 158 of the latch 106. The striker recess 164 is formed to selectively receive a striker 200 therein, as discussed in detail herein below. The reaction face 162 of the latch 106 is selectively engaged by the latch engagement face 140 of the locking member 104 to retain the latch 106 in a closed position. This engagement prohibits movement of the latch 106, thereby preventing the latch 106 from rotating.

The latch plate 108 includes a reaction face 176, a pivot aperture 178, and an attachment aperture 180. The latch plate 108 lies adjacent to the latch 106, whereby the latch pivot 168 is received through the pivot aperture 178. A rivet 182 is provided and received through the attachment aperture 180 to fix the latch plate 108 for rotation with the latch 106. The latch plate 108 extends a distance over the reaction face 162 of the latch 106.

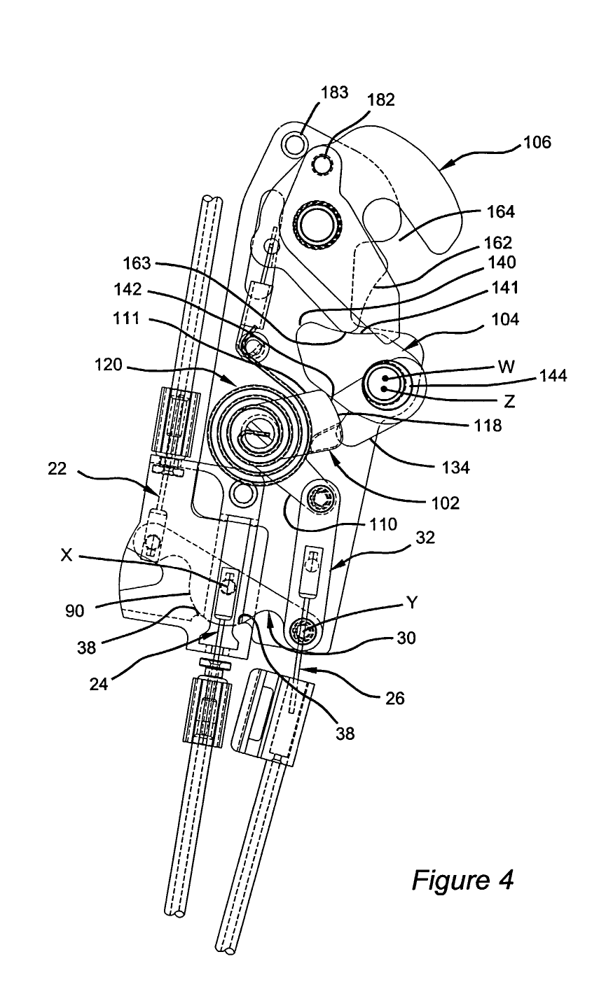

In the first operable mode, the valet cable 24 pulls the toggle lever 30 so that the reaction faces 90, 38 of the toggle lever 30 and the toggle housing 34 are in slidable contact, thereby establishing the pivot X. To unlatch the latch mechanism 10, a force is applied to the actuation cable 22 causing the toggle lever 30 to pivot clockwise (per the view of FIG. 4), which in turn pulls the link 32. The link 32 pulls the actuation arm 110, thereby rotating the cam 102 against the bias of the coil spring 120. As the cam 102 rotates, the cam engagement face 118 disengages the locking member 104. With continued rotation of the cam 102 the first extension 134 of the locking member 104 is received into the recess 112 of the cam 102, whereby the cam 102 pushes the arm 134 to rotate the lock member 104 about the pivot axis Z. In this manner, the locking member 104 disengages the latch 106. With the locking member 104 disengaged from the latch 106, the spring 166 biases the latch 106 to an open position (see FIG. 4) defined by the latch 106 abutting a rivet 183 and a point 163 of the latch 106 engaging a stop face 141 of the locking member 104.

To return the latch mechanism 10 to the latched position, the latch 106 is caused to rotate through engagement with a striker 200. The striker 200 causes the latch 106 to rotate clockwise relative to the housing 12, thereby disengaging the latch 106 from the locking member 104. Disengagement of the locking member 104 from the latch 106 enables the locking member 104 to pivot about the axis Z. Because the locking member 104 is now free to rotate, the spring bias from the coil spring 120 causes the cam 102 to rotate counterclockwise. Concurrently, rotation of the cam 102 pulls the link 32, thereby returning the toggle lever 30 to its latched position. Biased rotation of the cam 102 disengages the cam recess 112 from the first extension 134 of the locking member 104. Further rotation of the cam 102 enables the reaction face 118 of the cam 102 to engage the locking member 104, again biasing the latch engagement face 140 against the reaction face 162 to retain the latch 106 in the latched position.

In the second operable mode, the valet cable 24 is remotely actuated to remove the toggle lever 30 and toggle housing 34 from engagement with one another. In this manner, the actuation pivot point of the toggle lever 30 shifts, whereby the toggle lever 30 pivots about axis Y. For example, when in the second operable mode, pulling of the actuation cable 22 pulls on the toggle lever 30, thereby causing the toggle lever 30 to pivot about axis Y, pulling the released valet cable 24 as it pivots. In this manner, the toggle assembly 14 is ineffective for actuating the latch assembly 16 to the unlatched position.

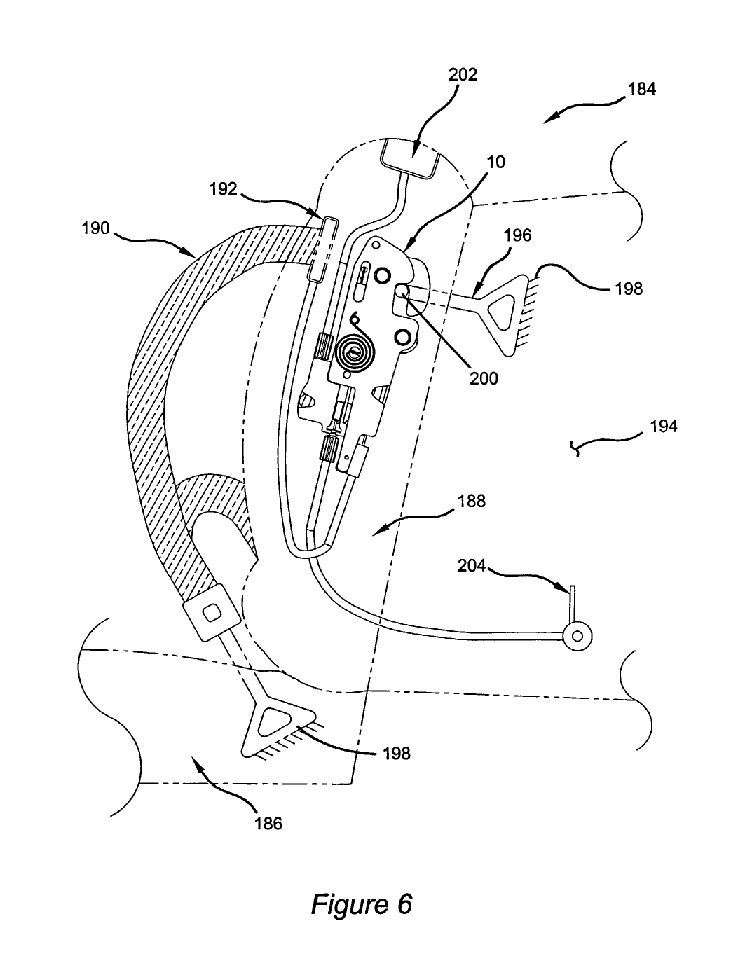

With respect to FIG. 6, a seat assembly 184 is shown incorporating the latch mechanism 10 of the present invention. The seat assembly 184 includes the latch mechanism 10, a seat bottom 186, a seat back 188, pivotably supported by the seat bottom 186 and a seatbelt assembly 190 including a seatbelt retractor 192. In an upright position, the seat back 188 blocks interior access to a cargo area 194. A striker assembly 196 is shown and is fixedly attached to a vehicle structure 198. The latch mechanism 10 selectively engages the striker 200 to secure the seatback 188 in the upright position. A remote actuation lever 202 is provided and is in mechanical communication with the toggle lever 30 through the actuation cable 22. Also, a remote valet lever 204 is provided and is located in the cargo area 194. The remote valet lever 204 is in mechanical communication with the toggle lever 30 through the valet cable 24.

The latch mechanism 10 is unlatched from the striker 200, and thus the vehicle structure 198, via remote actuation of the actuation lever 202, whereby the seat back 188 is enabled to pivot about a pivot point and subsequently, interior access to the cargo area 198 is enabled. In the second operable mode, the valet cable 24 is relaxed, thereby shifting the pivot axis of the toggle lever to axis Y, as described above. Although the this prevents the seatback 188 from being unlatched from the striker 200 by rendering the actuation cable 22 ineffective, the actuation lever 202 itself is still operable. In this manner, an operator will not be caused to apply excessive force to the actuation lever 202, believing it to be stuck. Since the seat back 188 remains anchored to the vehicle structure 198, access to the cargo area 194 of the vehicle is prevented.

In another embodiment, the latch mechanism 10 is operably interconnected with a remote device, such as the seatbelt retractor 192. This interconnection is generally established via the retractor cable 26, which is in mechanical communication with one of the toggle member 30 and the latch assembly 16. As shown in the figures, the retractor cable 26 is attached to the link 32. When the latch mechanism 10 is in an unlatched position the retractor cable 26 is relaxed due to the position of the link 32, rendering the seatbelt retractor 192 inoperable. When the latch mechanism 10 is in the proper latched position, the actuation cable 22 is taught, thereby enabling operation of the seatbelt retractor 192. In this manner, an occupant is prohibited from using the seatbelt 190 if the seat back 188 is not properly secured to the striker 200. This informs the occupant of an unsafe situation, so that the occupant may properly secure the seat back 188 to the striker 200.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A seat latch mechanism, comprising:
a housing;
a latch assembly operably supported by said housing; and
a toggle lever slidably supported by said housing and in operable communication with said latch assembly for selectively actuating said latch assembly between a latched and unlatched position, said toggle lever movable between first and second modes for respectively establishing a first pivot axis and a second pivot axis, wherein in said first mode said toggle lever is operable for actuating said latch assembly and in said second mode said toggle lever is inoperable for actuating said latch assembly.

2. The seat latch mechanism of claim 1, wherein said first pivot axis is disposed through an intermediate length of said toggle lever.

3. The seat latch mechanism of claim 1, wherein said second pivot axis is disposed through a distal end of said toggle lever.

4. The seat latch mechanism of claim 1, further comprising a link operably attached to said toggle lever for selectively holding said toggle lever in said first mode.

5. The seat latch mechanism of claim 1, further comprising an actuation member operably attached to a distal end of said toggle lever for selectively actuating said toggle lever.

6. The seat latch mechanism of claim 5, wherein said actuation member is a cable.

7. The seat latch mechanism of claim 1, further comprising a remote actuation member operably interconnecting a remote device with one of said toggle member and said latch assembly, wherein when said latch assembly is in said unlatched position said remote device is inoperable.

8. The seat latch mechanism of claim 1, further comprising a link operably interconnecting said toggle lever and said latch assembly.

9. A seat latch mechanism comprising:
a housing;
a latch assembly operably supported by said housing, said latch assembly operable between a latched position and an unlatch position; and
a remote actuation member operably interconnecting a remote device with said latch assembly, wherein when said latch assembly is in said unlatched position said remote device is inoperable.

10. The seat latch mechanism of claim 9, further comprising a toggle lever slidably supported by said housing and in operable communication with said latch assembly for selectively actuating said latch assembly between said latched and unlatched positions, said toggle lever movable between first and second modes for respectively establishing first and second pivot axis, wherein in said first mode said toggle lever is operable for actuating said latch assembly and in said second mode said toggle lever is inoperable for actuating said latch assembly.

11. The seat latch mechanism of claim 10, wherein said first pivot axis is disposed through an intermediate length of said toggle lever.

12. The seat latch mechanism of claim 10, wherein said second pivot axis is disposed through a distal end of said toggle lever.

13. The seat latch mechanism of claim 10, further comprising a moving member operably attached to said toggle lever for selectively holding said toggle lever in said first mode.

14. A seat assembly selectively attachable to a striker, comprising:
a seat bottom;
a seat back pivotally supported by said seat bottom; and
a seat latch mechanism selectively engaging said striker, said seat latch mechanism including:
a housing;
a latch assembly operably supported by said housing; and
a toggle lever slidably supported by said housing and in operable communication with said latch assembly for selectively actuating said latch assembly between a latched and unlatched position for selectively engaging said striker, said toggle lever movable between first and second modes for respectively establishing first and second pivot axis, wherein in said first mode said toggle lever is operable for actuating said latch assembly and in said second mode said toggle lever is inoperable for actuating said latch assembly.

15. The seat assembly of claim 14, wherein said first pivot axis is disposed through an intermediate length of said toggle lever.

16. The seat assembly of claim 14, wherein said second pivot axis is disposed through a distal end of said toggle lever.

17. The seat assembly of claim 14, further comprising a moving lever operably attached to said toggle lever, said moving lever operable for selectively holding said toggle lever in said first mode.

18. The seat assembly of claim 14, further comprising an actuation lever operably attached to a distal end of said toggle lever, said actuation lever operable for selectively actuating said toggle lever.

19. The seat assembly of claim 18, wherein said actuation member is a cable.

20. The seat assembly of claim 14, further comprising a remote actuation member operably interconnecting a remote device with one of said toggle member and said latch assembly, wherein when said latch assembly is in said unlatched position said remote device is inoperable.

21. The seat assembly of claim 20, wherein said remote device is a seatbelt retractor.

22. The seat assembly of claim 14, further comprising a link operably interconnecting said toggle lever and said latch assembly.
